(19) United States
(12) Patent Application Publication
(10) Pub. No.: US 2015/0149801 A1
(43) Pub. Date: May 28, 2015

(54) COMPLEX WAKEUP GESTURE FRAMEWORK

(71) Applicant: Synaptics Incorporated, San Jose, CA (US)

(72) Inventors: Tom Vandermeijden, Los Gatos, CA (US); Pranjal Jain, San Jose, CA (US)

(73) Assignee: Synaptics Incorporated, San Jose, CA (US)

(21) Appl. No.: 14/091,171

(22) Filed: Nov. 26, 2013

(51) Int. Cl. G06F 1/32; G06F 3/0488

(52) U.S. Cl. CPC G06F 1/3203; G06F 3/04883; G06F 2203/04808
USPC 713/323

(57) ABSTRACT

A processing system for sensing includes a sensor module including sensor circuitry coupled to sensor electrodes, the sensor module configured to generate sensing signals received with the sensor electrodes. The processing system further includes a determination module that is configured to determine, from the sensing signals, a positional information for a gesture while a host device is in low power mode, determine, based on the positional information and while the host device is in the low power mode, that the gesture is deliberate input, send, in response to determining that the gesture is deliberate input, a wake signal to the host device to switch the host device out of the low power mode, and send the positional information to the host device after the host device receives the wake signal.

### FIELD OF THE INVENTION

This invention generally relates to electronic devices.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, embodiments relate to a processing system for sensing. The processing system includes a sensor module including sensor circuitry coupled to sensor electrodes, the sensor module configured to acquire sensing signals with the sensor electrodes. The processing system further includes a determination module that is configured to determine, from the sensing signals, a positional information corresponding to a gesture while a host device is in low power mode, determine, based on the positional information and while the host device is in the low power mode, that the gesture is deliberate input, send, in response to determining that the gesture is deliberate input, a wake signal to the host device to switch the host device out of the low power mode, and send the positional information to the host device after the host device receives the wake signal.

In general, in one aspect, embodiments relate to a system including an input device including sensor electrodes configured to generate sensing signals, and a processing system. The processing system is configured to determine, from the sensing signals, a positional information corresponding to a gesture while a host device is in low power mode, determine, based on the positional information and while the host device is in the low power mode, that the gesture is deliberate input, and send, in response to determining that the gesture is deliberate input, a wake signal to the host device to switch the host device out of the low power mode, and send the positional information to the host device after the host device receives the wake signal. The system further includes a host device configured to switch out of the low power mode based on the wake signal, and analyze the positional information based on receiving the positional information.

In general, in one aspect, embodiments relate to a method for sensing including determining a positional information corresponding to a gesture while a host device is in low power mode, determining, based on the positional information and while the host device is in the low power mode, that the gesture is deliberate input, sending, in response to determining that the gesture is deliberate input, a wake signal to the host device to switch the host device out of the low power mode, and sending the positional information to the host device after the host device receives the wake signal.

Other aspects of the invention will be apparent from the following description and the appended claims.

### BRIEF DESCRIPTION OF DRAWINGS

FIGS. 1 and 2 show schematic diagrams in accordance with one or more embodiments of the invention.

FIGS. 3 and 4 show flowcharts in accordance with one or more embodiments of the invention.

FIG. 5 shows an example in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a framework for complex wakeup gestures. Specifically, the framework provides a bifurcated system that whereby an input device (discussed below) distinguishes between gestures that are incidental inputs versus gestures that are deliberate inputs, while the host device, for deliberate inputs of complex gestures, identifies the action to perform based on the complex gesture. Thus, the host device is not unduly awakened or switched out of low power mode for incidental inputs while the system as a whole is capable of supporting complex gestures. In one or more embodiments of the invention, the input device may further recognize simple gestures and map the simple gestures to the actions to be performed based on the simple gestures.

As used in this application, the term “incidental input” refers to detected input (i.e., input detected by the input device) that is not intended by the user to result in an action performed by the input device or host device. For example, incidental input may be a user's fingers accidentally touching the input device, one or more keys or other such object touching the input device while in the user's pocket or bag, a pet stepping on the input device, or other input detected by the input device that is not intended to result in an action of the input device.

As used in this application, the term “deliberate input” refers to detected input that is intended by the user to result in an action performed by the input device or host device. For example, deliberate input may be an attempt by a user to perform an input device recognized gesture or host device recognized gesture, such as by using an input object of some type or fingers of the user.

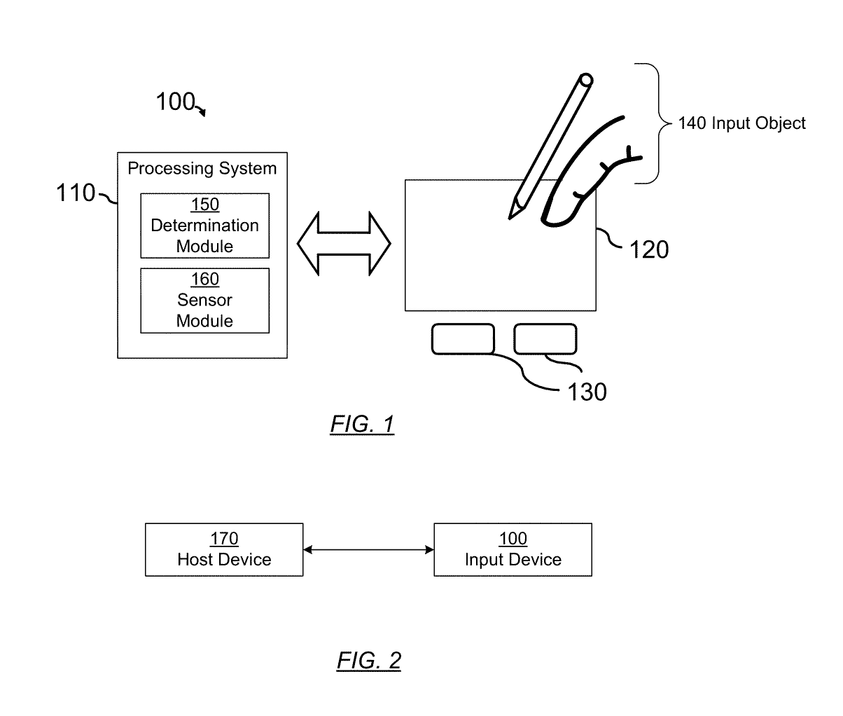

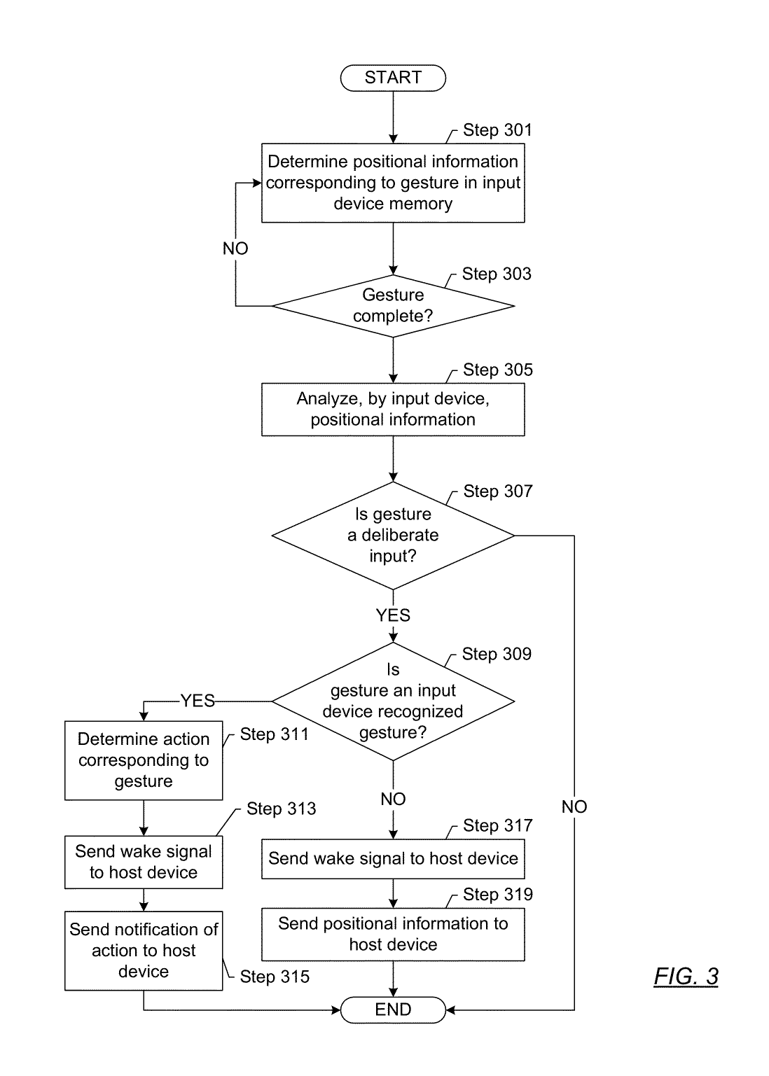

FIGS. 1 and 2 show schematic diagrams in accordance with one or more embodiments of the invention. In FIG. 1, the input device (100) is shown as a proximity sensor device (also often referred to as a “touchpad”, “touch screen”, or a “touch sensor device”) configured to sense input provided by one or more input objects (140) in a sensing region (120). Example input objects include pen, stylus, fingers, keys, palm, and other objects that may be in the sensing region (120).

Sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment. In some embodiments, the sensing region (120) extends from a surface of the input device (100) in one or more directions into space until signal-to-noise ratios prevent sufficiently accurate object detection. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that includes no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a trans capacitance sensing method operates by detecting the capacitive coupling between one or more transmitter sensor electrodes (also “transmitter electrodes”) and one or more receiver sensor electrodes (also “receiver electrodes”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may include effect(s) corresponding to one or more transmitter signals, and/or to one or more sources of environmental interference (e.g. other electromagnetic signals). Sensor electrodes may be dedicated transmitters or receivers, or may be configured to both transmit and receive.

Some optical techniques utilize optical sensing elements (e.g., optical transmitters and optical receivers). Such optical transmitters transmit optical transmitter signals. The optical receivers include functionality to receive resulting signals from the optical transmitter signals. A resulting signal may include effect(s) corresponding to one or more transmitter signals, one or more input objects (140) in the sensing region, and/or to one or more sources of environmental interference. For example, the optical transmitters may correspond to a light emitting diode (LED), organic LED (OLED), light bulb, or other optical transmitting component. In one or more embodiments, the optical transmitter signals are transmitted on the infrared spectrum.

In FIG. 1, a processing system (110) is shown as part of the input device (100). The processing system (110) is configured to operate the hardware of the input device (100) to detect input in the sensing region (120). The processing system (110) includes parts of or all of one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes). In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to sensing element(s) of input device (100), and one or more components elsewhere. For example, the input device (100) may be a peripheral coupled to a computer, and the processing system (110) may include one or more ICs (perhaps with associated firmware) separate from the central processing unit of the computer. As another example, the input device (100) may be physically integrated in a phone. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, determine whether the gesture formed by the positional information is an input device recognized gesture, determine whether the gesture is a deliberate or incidental input, perform other determinations, or a combination thereof.

The sensor module (160) may include functionality to drive the sensing elements to transmit transmitter signals and receive resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures such as mode changing gestures, and mode changing modules for changing operation modes.

In some embodiments, the processing system (110) responds to user input (or lack of user input) in the sensing region (120) directly by causing one or more actions by a host device. Example actions include changing operation modes, as well as GUI actions such as cursor movement, selection, menu navigation, and other functions. In some embodiments, the processing system (110) provides information about the input (or lack of input) to some part of the electronic system (e.g. to a central processing system of the electronic system that is separate from the processing system (110)). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. As another example, the display screen may be operated in part or in total by the processing system (110).

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer readable storage medium. Examples of non-transitory, electronically readable media include various discs, physical memory, memory, memory sticks, memory cards, memory modules, and or any other computer readable storage medium. Electronically readable media may be based on flash, optical, magnetic, holographic, or any other storage technology.

Although not shown in FIG. 1, the processing system, the input device, and/or the host device may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores, or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

Turning to FIG. 2, the input device (100) may be configured to provide input to a host device (170). The host device is any electronic system capable of electronically processing information. Some non-limiting examples of host devices include personal computers of all sizes and shapes, such as desktop computers, laptop computers, netbook computers, tablets, web browsers, e-book readers, and personal digital assistants (PDAs). Other example host devices include remote terminals, kiosks, and video game machines (e.g., video game consoles, portable gaming devices, and the like). Other example host devices include communication devices (including cellular phones, such as smart phones), and media devices (including recorders, editors, and players such as televisions, set-top boxes, music players, digital photo frames, and digital cameras).

The input device (100) can be implemented as a physical part of the host device (170), or can be physically separate from the host device (170). As appropriate, the input device (100) may communicate with parts of the host device (170) using any one or more of the following: buses, networks, and other wired or wireless interconnections. Examples include I2C, SPI, PS/2, Universal Serial Bus (USB), Bluetooth, RF, and IRDA.

In one or more embodiments of the invention, the host device (170) is separate from the input device (100) in that the host device may be in a low power mode while the input device (100) is processing positional information. In one or more embodiments of the invention, low power mode is an off state of the application processor on the host device. For example, the low power mode may be a sleep mode, a standby mode, a suspend mode, or other such mode. While in the low power mode, the display may be in an off state.

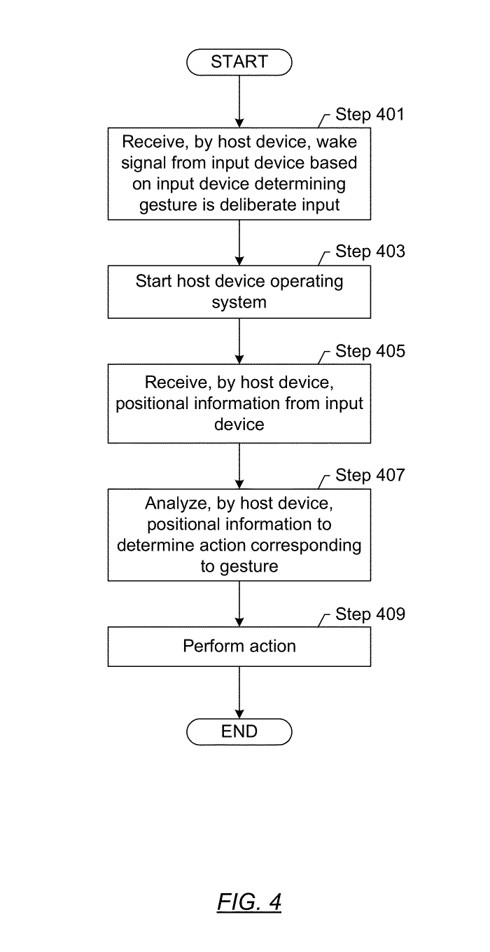

FIGS. 3 and 4 show flowcharts in accordance with one or more embodiments of the invention. While the various steps in these flowcharts are presented and described sequentially, some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that a condition exists in accordance with one or more embodiments of the invention. As another example, determination steps may be performed by performing a test, such as checking a data value to test whether the value is consistent with the tested condition in accordance with one or more embodiments of the invention.

FIG. 3 shows a flowchart for an input device to process positional information. In Step 301, positional information is determined and stored in input device memory in accordance with one or more embodiments of the invention. The positional information corresponds to a gesture in accordance with one or more embodiments of the invention. In particular, the input device may regularly monitor the sensing region for presence of one or more input objects. Monitoring the sensing region may include the sensor module generating sensing signals. In particular, sensor electrodes transmit transmitter signals and resulting sensing signals are received or acquired by sensor electrodes. The sensor electrodes that transmit the transmitter signals may be the same or different than the sensor device that receive the resulting signals. When an input object is in the sensing region, the resulting sensing signals exhibit a change in value from the transmitter signals even accounting for noise in the sensing region. By processing the resulting signals, including removing noise, positional information may be gathered. As discussed above, the positional information may include the location of the input object in the sensing region, the strength of the signal, width of the input object, and other such information.

In Step 303, a determination is made whether the gesture is complete in accordance with one or more embodiments of the invention. The gesture may be determined complete, for example, when the input object is no longer detected in the sensing region, when a threshold amount of time has passed since the input object is last detected in the sensing region, based on one or more other criterion, or combination thereof. If the gesture is not complete, then the input device may continue capturing positional information.

Alternatively or while the gesture is being performed, the input device may analyze the positional information in Step 305. Analyzing the positional information may include determining whether the gesture is a part of a deliberate input or an incidental input. In one or more embodiments of the invention, a set of exclusionary rules are applied to the gesture. Each exclusionary rule identifies gestures that are likely to be incidental inputs. In other words, if a gesture is identified as potentially incidental input by a threshold number of exclusionary rules, then the gesture is determined to be incidental input. In one or more embodiments of the invention, the threshold number of exclusionary rules is one. In other embodiments of the invention, the threshold number may be more than one thereby requiring the gesture to be excluded by multiple exclusionary rules before being determined as incidental input. If all the exclusionary rules are satisfied, then the gesture may be determined to be deliberate input. Below are some examples of exclusionary rules and ways to use the exclusionary rules to analyze the positional information.

In one or more embodiments of the invention, an exclusionary rule specifies a maximum number of input objects detected in the sensing region during the gesture. By way of an example, the maximum number may be one or two. More than the maximum number of input objects may indicate that the input objects are merely brushing against the sensing region, such as keys or other objects, when the host device and input device are in a bag. Determining a number of input objects may be performed directly from the positional information. Specifically, the positional information includes a position of each input object detected in the sensing region at each point in time. Thus, the number of input objects may be based on the number of positions of input objects in the sensing region.

In one or more embodiments of the invention, an exclusionary rule may be based on the length of the path of the first gesture. Specifically, the exclusionary rule may be defined such that the shorter the path length the more likely that the gesture is deemed an incidental input. For example, gestures that are short may indicate that the gesture is incidental input, such as an accidental pen touching the input object. In one or more embodiments of the invention, to determine whether the exclusionary rule is satisfied, a length of a path of the gesture is obtained and compared against a length threshold. If the length satisfies the length threshold, such as by being at least greater than the length threshold, then the exclusionary rule may be deemed satisfied.

In one or more embodiments of the invention, the length threshold that is applied may be based on the direction of the path. By way of an example, consider the scenario in which the surface of the sensing region is 2.75 inches by 5.5 inches. In the example, if the direction is along the shorter 2.75 inch side, then the length threshold may be 1 inch whereas if the direction is along the longer 5.5 inches, then the length threshold may be 2 inches. The length threshold may be a real number, a percentage of the total possible length along a particular direction, or specified using another technique.

In one or more embodiments of the invention, an exclusionary rule may be based on the linearity of the path. Specifically, the exclusionary rule may be defined such that the more linear the path is, the less likely the gesture is a deliberate gesture. In other words, complex gestures may be deemed less linear. The linearity of the path may be determined, for example, by calculating a line of best fit to a representative set of points of the gesture. An amount of deviation of the representative set of points from the line of best fit may be calculated and used as a metric defining the linearity of the path. If the linearity of the path satisfies a linearity threshold, then the gesture may be deemed a deliberate input. If the linearity of the path does not satisfy the linearity threshold, then the gesture may be deemed to be an incidental input.

In one or more embodiments of the invention, an exclusionary rule may be based on the amount of variability in an input object size of the input object forming the first gesture. Specifically, the exclusionary rule may specify that the greater the variability, the less likely that the gesture is a deliberate input in accordance with one or more embodiments of the invention. In one or more embodiments of the invention, the variability of the input object size may be determined by calculating a standard deviation of the input object size of the course of the performance of the gesture. If the standard deviation or other metric defining the variability of the input object size does not satisfy a variability threshold, then the gesture may be determined to be an incidental input.

In one or more embodiments of the invention, an exclusionary rule may be based on the velocity of the input object. Specifically, the exclusionary rule may specify that if the average velocity or other statistic of the velocity does not satisfy the velocity threshold then the gesture is an incidental input. In order to determine whether the velocity threshold is satisfied, the velocity of the input object forming the gesture is obtained. As discussed above, the obtained velocity may be calculated as average velocity or other statistic defining the velocity over the course of the gesture. The velocity is compared with a velocity threshold defining a minimum allowed velocity to determine whether the velocity threshold is satisfied. If the velocity threshold is satisfied, the input may be determined to be a deliberate input. If the velocity threshold is not satisfied, the input may be determined to be an incidental input.

In one or more embodiments of the invention, an exclusionary rule may be based on the position of the path of the gesture. Specifically, the exclusionary rule may specify that if the average position or other statistic of the position does not satisfy the position threshold then the gesture is an incidental input. In order to determine whether the position threshold is satisfied, the position of the input object forming the gesture is obtained. As discussed above, the obtained position may be calculated as average position or other statistic defining the position over the course of the gesture as a measurement from the edge of the sensing region. The position is compared with a position threshold defining a minimum allowed position from the edge of the sensing region to determine whether the position threshold is satisfied. If the position threshold is satisfied, the input may be determined to be a deliberate input. If the position threshold is not satisfied, the input may be determined to be an incidental input.

The above discussion includes only a few examples of exclusionary rules. Other or additional exclusionary rules may be used without departing from the scope of the invention.

Continuing with FIG. 3, in Step 307, a determination is made whether the gesture is a deliberate input in accordance with one or more embodiments of the invention. Determining whether the gesture is a deliberate input may be performed based on the number and/or which exclusionary rules are satisfied. In one or more embodiments of the invention, a threshold number of the exclusionary rules must be satisfied in order for the gesture to be determined to be a deliberate input. In some embodiments, the threshold number is all exclusionary rules. In other embodiments, the threshold number is a predefined number that is a subset of the exclusionary rules. For example, if two exclusionary rules are not satisfied and the remaining are satisfied, then the gesture may still be deemed to be a deliberate input. Alternatively or additionally, subsets of exclusionary rules may be dependent on each other such that all exclusionary rules in the subset must all be satisfied for the gesture to be deemed to be a deliberate input. Alternatively or additionally, subsets of exclusionary rules may be dependent on each other such that only when none of the exclusionary rules in the subset is the gesture deemed to be an incidental input.

If the gesture is an incidental input, then the gesture is dropped. For example, the gesture may be ignored and the memory storing the positional information may be marked as available.

If the gesture is determined to be a deliberate input, then the method may proceed to further analyze the gesture. In one or more embodiments of the invention, the further analysis may include determining whether the gesture is a gesture recognized by the input device in Step 309. Determining whether the gesture is one recognized by the input device includes determining whether the positional information matches stored gesture on the input device. In particular, the input device may store a set of simple gestures that the input device may recognize. Such gestures may include, for example, a finger swipe, a circle, a triangle, or any other such gesture.

If the gesture is an input device recognized gesture, then an action corresponding to the gesture is determined in Step 311 in one or more embodiments of the invention. In one or more embodiments of the invention, the stored gesture has a corresponding defined action in storage. Thus, the action matching the stored gesture that matches the positional information is obtained in Step 311.

In Step 313, a wake signal is sent to the host device to transition the host device from low power mode. When the host device receives the wake signal, the host device switches out of low power mode. In Step 315, a notification of the action is sent to the host device. For example, the host device, after switching out of low power mode, may issue a read request to the input device to read the action and, optionally, the positional information. In response, the input device may send the notification of the action to the host device.

If the gesture is not an input device recognized gesture and the gesture is determined by the input device to be a deliberate input, then a wake signal is sent to the host device in Step 317. The wake signal transitions the host device out of low power mode. By sending a wake signal to the host device only after determining that the gesture is not incidental input, but rather deliberate input, the host device may be spared from unduly spending extra energy to process every detected input in the sensing region while at the same time allowing for more complex gestures to be analyzed.

In Step 319, positional information is sent to the host device. For example, the host device, after switching out of low power mode, may issue a read request to the input device to read the positional information. The read request may be to read anything that is stored and waiting for processing. In response, the input device may send the positional information to the host device for processing by the host device.

FIG. 4 shows a flowchart for processing on the host device when the input device detects a deliberate input in accordance with one or more embodiments of the invention. In Step 401, the host device receives a wake signal from the input device based on the input device determining that the gesture is a deliberate input. The wake signal may be, for example, an interrupt to the processor to start processing instructions.

In Step 403, the host device operating system is started in response to the wake signal in accordance with one or more embodiments of the invention. Starting the host device operating system may include, for example, transitioning the host device out of low power mode by obtaining current state information from memory and processing instructions of the host device operating system.

In Step 405, the host device receives positional information from the input device. The positional information may be received, for example, by the host device operating system, by a device driver, or by another component on the host device while the host device is no longer in low power mode. In Step 407, the host device analyzes the positional information to determine the action corresponding to the gesture. For example, the host device may compare the positional information with recognized gestures to identify the corresponding action to perform.

In Step 409, the action is performed in accordance with one or more embodiments of the invention. The action of the host device or input object may include displaying a user interface on the display screen, opening a particular application, unlocking the host device, performing an action by the particular application, or performing another action or combination thereof. The action may be to drop the positional information and gesture. For example, the gesture may be a deliberate input by a nefarious individual who did not perform the gesture correctly. In such a scenario, even though the input device correctly determined that the gesture is a deliberate input, the host device determined that the gesture is not recognized and drops the gesture.

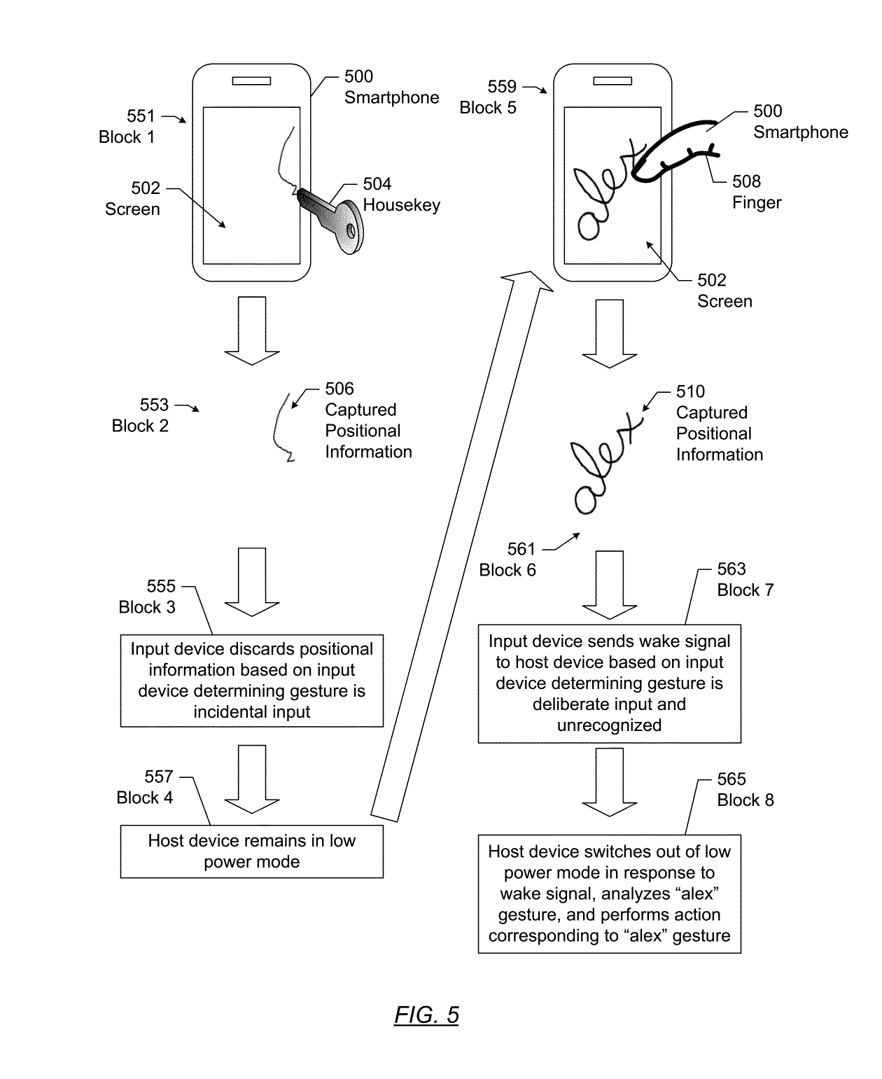

FIG. 5 shows an example in accordance with one or more embodiments of the invention. The following example is for explanatory purposes only and not intended to limit the scope of the invention. In the following example, consider the scenario in which Alex, a high school student, has a smartphone (500). While Alex is in class, Alex stores his smart phone safely in his backpack. However, when Alex is out of class, he uses his smartphone (500) to play games and text friends. Alex may start his text messaging application by writing “Alex” on the screen (502) of the smartphone (500).

FIG. 5 shows an example timing diagram of Alex using his smartphone (500). At time t1 shown in Block 1 (551), Alex is in math class with his smartphone and house key (504) in his backpack. The smartphone is in low power mode to conserve power. Unbeknownst to Alex, his house key (504) comes in contact with the screen (502) of his smartphone and performs a gesture.

The input device of his screen (502) and associated circuitry captures positional information (506) as shown in Block 2 (553). Without transitioning the smartphone out of low power mode, the input device analyzes the captured positional information (506).

As shown in Block 3 (555), the input device discards the positional information based on determining that the gesture is incidental input. Specifically, the gesture is determined to be incidental input based on being close to the edge of the sensing region, short as compared to the size of the sensing region, and having a low velocity. Thus, the host device remains in low power mode (Block 4 (557)).

Continuing with the example, after leaving math class, Alex is excited to check his text messages. Thus, as shown in Block 5 (559), Alex draws “Alex” on the screen (502) of his smartphone (500) with his finger (508). The input device and associated circuitry captures positional information (510) as shown in Block 6 (561) while keeping the host device remaining in low power mode.

The input device and associated circuitry analyze the positional information. Based on the input device determining that the gesture is a deliberate input and unrecognized by the input device, the input device sends a wake signal to the host device as shown in Block 7 (563). Specifically, the various exclusionary rules are satisfied by the “Alex” gesture, thereby, indicating that the gesture is a deliberate input.

Only after receiving the wake signal, the host device switches out of low power mode in response to the wake signal, analyzes the “Alex” gesture, and performs the action corresponding to the “Alex” gesture as shown in Block 8 (565). As shown in the example, by the host device only waking for deliberate actions that are complex gestures, the host device is able to remain in low power mode and extend the battery life while at the same time allowing for use of complex gestures.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A processing system for sensing, comprising:
a sensor module comprising sensor circuitry coupled to a plurality of sensor electrodes, the sensor module configured to acquire sensing signals with the plurality of sensor electrodes; and
a determination module configured to:
determine, from the sensing signals, first positional information corresponding to a first gesture while a host device is in low power mode,
determine, based on the first positional information and while the host device is in the low power mode, that the first gesture is deliberate input,
send, in response to determining that the first gesture is deliberate input, a wake signal to the host device to switch the host device out of the low power mode, and
send the first positional information to the host device after the host device receives the wake signal.

2. The processing system of claim 1, wherein the determination module is further configured to:
determine, from the sensing signals, second positional information corresponding to a second gesture while the host device is in low power mode,
determine, based on the second positional information and while the host device is in the low power mode, that the second gesture is incidental input, and
drop, in response to determining that the second gesture is incidental input, the second positional information without sending a wake signal to the host device to switch the host device out of low power mode.

3. The processing system of claim 1, wherein determining that the first gesture is deliberate input comprises:
comparing the first positional information to a plurality of exclusionary rules, and
determining that the plurality of exclusionary rules is satisfied.

4. The processing system of claim 3, wherein the plurality of exclusionary rules comprises an exclusionary rule that specifies a maximum number of input objects in the sensing region during the first gesture.

5. The processing system of claim 1, wherein determining that the first gesture is deliberate input comprises:
obtaining a length of a path of the first gesture, and
determining that the length of the path satisfies a length threshold.

6. The processing system of claim 1, wherein determining that the first gesture is deliberate input comprises:
obtaining a linearity of a path forming the first gesture, and
determining that the linearity satisfies a linearity threshold.

7. The processing system of claim 1, wherein determining that the first gesture is deliberate input comprises:
measuring an amount of variability in an input object size forming the first gesture, and
determining that the amount of variability satisfies a variability threshold.

8. The processing system of claim 1, wherein determining that the first gesture is deliberate input comprises:
obtaining a velocity of an input object forming the first gesture, and
determining that the velocity satisfies a velocity threshold.

9. The processing system of claim 1, wherein determining that the first gesture is deliberate input comprises:
identifying a position of the first gesture, and
determining that the position is a threshold distance from an edge of the sensing region.

10. The processing system of claim 1, wherein the determination module is further configured to:
determine, from the sensing signals, second positional information corresponding to a second gesture while the host device is in low power mode,
determine, based on the second positional information and while the host device is in the low power mode, that the second gesture is deliberate input,
determine, based on the second positional information and while the host device is in the low power mode, that the second gesture is an input device recognized gesture,
determine, while the host device is in the low power mode, an action corresponding to the input device recognized gesture, and
send, in response to determining that the second gesture is deliberate input and the action, a wake signal and a notification of the action to the host device to switch the host device out of the low power mode and perform the action.

11. A system comprising:
an input device comprising:
a plurality of sensor electrodes configured to acquire sensing signals, and
a processing system configured to:
determine, from the sensing signals, a first positional information corresponding to a first gesture while a host device is in low power mode,
determine, based on the first positional information and while the host device is in the low power mode, that the first gesture is deliberate input, and
send, in response to determining that the first gesture is deliberate input, a wake signal to the host device to switch the host device out of the low power mode, and
send the first positional information to the host device after the host device receives the wake signal; and
a host device configured to:
switch out of the low power mode based on the wake signal, and
analyze the first positional information based on receiving the first positional information.

12. The system of claim 11, wherein analyzing the first positional information comprises:
identifying an action corresponding to the first positional information, and
wherein the host device is further configured to perform the action.

13. The system of claim 11, wherein the processing system is further configured to:
determine, from the sensing signals, a second positional information corresponding to a second gesture while the host device is in low power mode,
determine, based on the second positional information and while the host device is in the low power mode, that the second gesture is deliberate input,
determine, based on the second positional information and while the host device is in the low power mode, that the second gesture is an input device recognized gesture,
determine, while the host device is in the low power mode, an action corresponding to the input device recognized gesture, and
send, in response to determining that the second gesture is deliberate input and the action, a wake signal and a notification of the action to the host device to switch the host device out of the low power mode and perform the action, and
wherein the host device is further configured to perform the action in response to the wake signal and the notification of the action.

14. The system of claim 11, wherein the processing system is further configured to:
capture, from the sensing signals, a second positional information corresponding to a second gesture while the host device is in low power mode,
determine, based on the second positional information and while the host device is in the low power mode, that the second gesture is incidental input, and
drop, in response to determining that the second gesture is incidental input, the second positional information without sending a wake signal to the host device to switch the host device out of low power mode.

15. A method for sensing comprising:
determining a first positional information corresponding to a first gesture while a host device is in low power mode;
determining, based on the first positional information and while the host device is in the low power mode, that the first gesture is deliberate input;
sending, in response to determining that the first gesture is deliberate input, a wake signal to the host device to switch the host device out of the low power mode, and
sending the first positional information to the host device after the host device receives the wake signal.

16. The method of claim 15, further comprising:
determining, from the sensing signals, a second positional information corresponding to a second gesture while the host device is in low power mode,
determining, based on the second positional information and while the host device is in the low power mode, that the second gesture is incidental input, and
dropping, in response to determining that the second gesture is incidental input, the second positional information without sending a wake signal to the host device to switch the host device out of low power mode.

17. The method of claim 15, wherein determining that the first gesture is deliberate input comprises:
comparing the first positional information to a plurality of exclusionary rules, and
determining that the plurality of exclusionary rules is satisfied.

18. The method of claim 17, wherein the plurality of exclusionary rules comprises an exclusionary rule that specifies a maximum number of input objects in the sensing region during the first gesture.

19. The method of claim 15, further comprising:
determining, from the sensing signals, a second positional information corresponding to a second gesture while the host device is in low power mode,
determining, based on the second positional information and while the host device is in the low power mode, that the second gesture is deliberate input,
determining, based on the second positional information and while the host device is in the low power mode, that the second gesture is an input device recognized gesture,
determining, while the host device is in the low power mode, an action corresponding to the input device recognized gesture, and
sending, in response to determining that the second gesture is deliberate input and the action, a wake signal and a notification of the action to the host device to switch the host device out of the low power mode and perform the action.

20. The method of claim 15, wherein determining that the first gesture is deliberate input comprises:
obtaining a length of a path of the first gesture, and
determining that the length of the path satisfies a length threshold.
